(19) United States
(12) Patent Application Publication
(10) Pub. No.: US 2026/0140710 A1
(43) Pub. Date: May 21, 2026

(54) BRING YOUR OWN MODEL (BYOM) FOR INTEGRATION PLATFORM

(71) Applicant: BOOMI, LP, Conshohocken, PA (US)

(72) Inventors: Swagata ASHWANI, San Francisco, CA (US); Ayush PARASHAR, Foster City, CA (US); Edward MACOSKY, Livermore, CA (US)

(73) Assignee: BOOMI, LP, Conshohocken, PA (US)

(21) Appl. No.: 18/954,091

(22) Filed: Nov. 20, 2024

(51) Int. Cl. G06F 8/34; G06F 3/0486; G06F 8/70

(52) U.S. Cl. CPC G06F 8/34; G06F 8/70; G06F 3/0486

(57) ABSTRACT

State-of-the-art Integration Platform as a Service (iPaaS) platforms do not enable users to utilize their own artificial intelligence (AI) models (e.g., large language models or other generative model). Disclosed embodiments enable users to bring your own model (BYOM) within an integration platform. In particular, users may build or import their own AI model, and integrate that AI model into their integration processes in the same manner as any other integration step. This may involve dragging a shape, representing the AI model, from a virtual palette onto a virtual canvas, and configuring the corresponding AI step. During execution, the resulting integration process may automatically and dynamically, in real time, receive input data and retrieve contextual metadata to enhance the input data with context. The combination of input data and contextual metadata may be provided to the AI step to perform the desired task with improved accuracy.

### BACKGROUND

### Field of the Invention

The embodiments described herein are generally directed to artificial intelligence, and, more particularly, to enabling bring your own model (BYOM) in an integration platform.

### Description of the Related Art

Integration Platform as a Service (iPaaS) enables the integration of applications and data. The iPaaS platform provided by Boomi® of Conshohocken, Pennsylvania, enables users to construct integration processes from pre-built steps, visually represented as “shapes,” which each has a set of configuration properties. Each step dictates how an integration process retrieves data, manipulates data, routes data, sends data, and/or the like. These steps can be connected together in endless combinations to build simple to very complex integration processes.

Generative artificial intelligence (AI) models, including machine-learning models, such as large language models, have transformed the way that systems work. Recently, there has been interest in incorporating such AI models into integration platforms. This has resulted in a desire to provide customized and AI-integrated solutions to end users.

However, in existing integration platforms, users typically rely on pre-built and pre-trained machine-learning models that are selected and offered by the platform provider. These machine-learning models are often generic and do not fully address the specific needs of individual users and their organizations. There are no custom machine-learning models or other artificial intelligence, upon which users can build, and users are unable to add their own machine-learning models.

Users cannot tailor the pre-built and pre-trained models to their unique data or requirements, resulting in suboptimal performance and low accuracy in specific use cases. On top of this lack of customization, there is limited flexibility. Integration processes are constrained by the capabilities of the pre-built models, which limits the range of applications and custom solutions that can be developed. The existing AI models of iPaaS platforms also have static performance. In other words, the pre-trained models cannot improve or otherwise adapt based on individual user feedback or specific business contexts, resulting in stagnant performance over time.

### SUMMARY

Accordingly, systems, methods, and non-transitory computer-readable media are disclosed for enabling bring your own model (BYOM) in an integration platform.

In an embodiment, a method comprises using at least one hardware processor to: generate a graphical user interface comprising a virtual palette and a virtual canvas, wherein the virtual palette comprises one or more shapes, representing potential steps in an integration process, wherein the virtual canvas comprises a region onto which each shape, on the virtual palette, is draggable and droppable to construct the integration process, and wherein at least one of the one or more shapes represents an artificial intelligence (AI) step in which an AI model is executed; receive a user operation that comprises dragging and dropping the at least one shape, representing the AI model, onto the virtual canvas; receive a configuration of the AI step; incorporate software code, representing the AI step, configured according to the received configuration, into integration code representing the integration process; and deploy the integration process. The AI model may comprise a generative model. The generative model may be a generative language model. The generative language model may be a large language model.

The method may further comprise using the at least one hardware processor to, after deploying the integration process, execute the integration process, wherein executing the integration process comprises: receiving input data; retrieving contextual metadata; mapping the input data and the contextual metadata to an AI model input; executing the AI step to apply the AI model, configured according to the received configuration, to the AI model input to produce an AI model output; and executing at least one subsequent step, in the integration process, on the AI model output.

The AI model may comprise a machine-learning model. The AI model may be a large language model. Mapping the input data and the contextual metadata to the AI model input may comprise mapping an input schema, representing a structure of the input data and the contextual metadata, to an output schema. Executing the AI step may comprise: generating a prompt from the AI model input; and inputting the prompt to the large language model to produce the AI model output.

Deploying the integration process may comprise generating a runtime container that comprises the integration code, and wherein the integration process is executed within the runtime container. Deploying the integration process may further comprise running at least one instance of the runtime container in a computing cloud. The method may further comprise using the at least one hardware processor to dockerize the AI model into a model container that comprises the AI model and all dependencies of the AI model. Applying the AI model may comprise sending an input, derived from the AI model input, to the model container. Applying the AI model may further comprise sending one or more execution parameters, with the input derived from the AI model input, to the model container.

The input data may represent a transaction involving a customer, wherein the contextual metadata comprise customer information, including a transaction history, and wherein the AI model output indicates whether or not the transaction is fraudulent. The at least one subsequent step may comprise a decision step and two or more action steps, wherein the decision step branches to one of the two or more action steps based on the indication of whether or not the transaction is fraudulent, wherein a first one of the two or more action steps flags the transaction as fraudulent, and wherein a second one of the two or more action steps confirms the transaction as legitimate.

The input data may represent a website visit, wherein the contextual metadata comprise a browsing history, and wherein the AI model output comprises personalized marketing content. The at least one subsequent step may comprise generating at least one personalized communication from the personalized marketing content.

It should be understood that any of the features in the methods above may be implemented individually or with any subset of the other features in any combination. Thus, to the extent that the appended claims would suggest particular dependencies between features, disclosed embodiments are not limited to these particular dependencies. Rather, any of the features described herein may be combined with any other feature described herein, or implemented without any one or more other features described herein, in any combination of features whatsoever. In addition, any of the methods, described above and elsewhere herein, may be embodied, individually or in any combination, in executable software modules of a processor-based system, such as a server, and/or in executable instructions stored in a non-transitory computer-readable medium.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 illustrates an example infrastructure, in which one or more of the processes described herein may be implemented, according to an embodiment;

FIG. 2 illustrates an example processing system, by which one or more of the processes described herein may be executed, according to an embodiment;

FIG. 3 illustrates an example process for constructing an integration process, according to an embodiment;

FIG. 4 illustrates an example process for executing an integration process, according to an embodiment;

FIG. 5 illustrates a graphical user interface, according to an embodiment; and

FIGS. 6A and 6B illustrate example integration processes for specific use cases, according to an embodiment.

### DETAILED DESCRIPTION

In an embodiment, systems, methods, and non-transitory computer-readable media are disclosed for enabling bring your own model (BYOM) in an integration platform. It should be understood that the model may be any machine-learning (ML) model, including potentially a large language model (LLM), small language model (SLM), other generative model, a non-generative model, or any other ML model that may benefit from context, as well as any non-ML model that may benefit from context. After reading this description, it will become apparent to one skilled in the art how to implement the invention in various alternative embodiments and alternative applications. However, although various embodiments of the present invention will be described herein, it is understood that these embodiments are presented by way of example and illustration only, and not limitation. As such, this detailed description of various embodiments should not be construed to limit the scope or breadth of the present invention as set forth in the appended claims.

### 1. Infrastructure

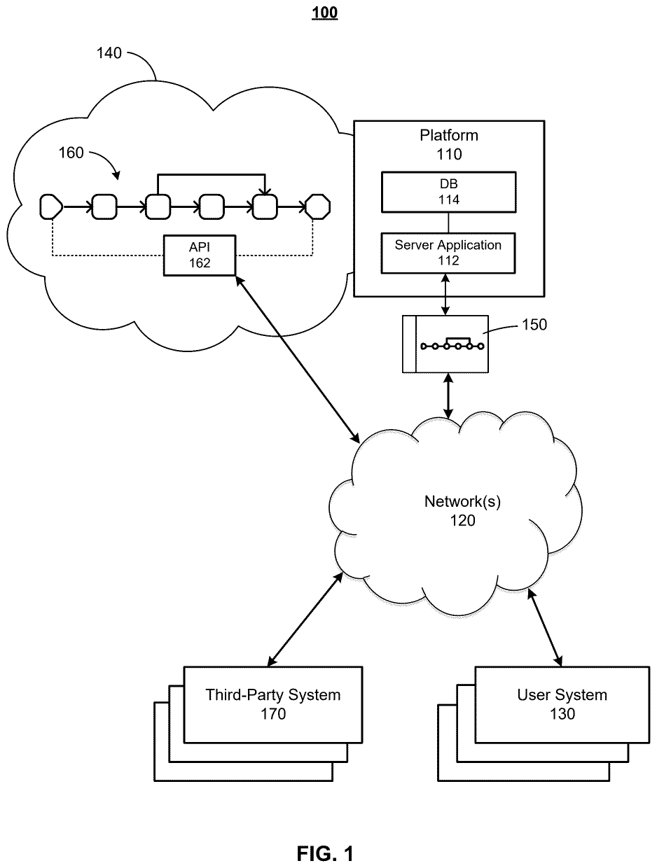

FIG. 1 illustrates an example infrastructure 100, in which one or more of the processes described herein may be implemented, according to an embodiment. Infrastructure 100 may comprise a platform 110 which hosts and/or executes one or more of the disclosed processes, which may be implemented in software and/or hardware. In particular, platform 110 may execute a server application 112 and/or host a database 114 that may store data used by server application 112. Platform 110 may comprise dedicated servers, or may instead be implemented in a computing cloud, in which the resources of one or more servers are dynamically and elastically allocated to multiple tenants based on demand. In either case, the servers may be collocated and/or geographically distributed.

Platform 110 may be communicatively connected to one or more networks 120. Network(s) 120 enable communication between platform 110 and user system(s) 130. Network(s) 120 may comprise the Internet, and communication through network(s) 120 may utilize standard transmission protocols, such as HyperText Transfer Protocol (HTTP), HTTP Secure (HTTPS), File Transfer Protocol (FTP), FTP Secure (FTPS), Secure Shell FTP (SFTP), and the like, as well as proprietary protocols. While platform 110 is illustrated as being connected to a plurality of user systems 130 through a single set of network(s) 120, it should be understood that platform 110 may be connected to different user systems 130 via different sets of one or more networks. For example, platform 110 may be connected to a subset of user systems 130 via the Internet, but may be connected to another subset of user systems 130 via an intranet.

While only a few user systems 130 are illustrated, it should be understood that platform 110 may be communicatively connected to any number of user system(s) 130 via network(s) 120. User system(s) 130 may comprise any type or types of computing devices capable of wired and/or wireless communication, including without limitation, desktop computers, laptop computers, tablet computers, smart phones or other mobile phones, servers, game consoles, televisions, set-top boxes, electronic kiosks, point-of-sale terminals, and/or the like. However, it is generally contemplated that a user system 130 would be the personal computer or professional workstation of an integration developer that has a user account for accessing server application 112 on platform 110. It should be understood that the integration developer may be anywhere from a novice, with little to no prior experience in integration development, to an expert, with many years of experience in integration development. When platform 110 is an iPaaS platform, each user account may be associated with an overarching organizational account for managing an integration platform on the iPaaS platform.

Server application 112 may manage an integration environment 140. In particular, server application 112 may provide a user interface 150 and backend functionality, including one or more of the processes disclosed herein, to enable users, via user systems 130, to construct, develop, modify, save, delete, test, deploy, un-deploy, and/or otherwise manage integration processes 160 within integration environment 140. User interface 150 may comprise a graphical user interface that implements a low-code environment, including potentially a no-code environment, in which users may construct integration processes 160.

The user of a user system 130 may authenticate with platform 110 using standard authentication means, to access server application 112 in accordance with permissions or roles of the associated user account. The user may then interact with server application 112 to manage one or more integration processes 160, for example, within a larger integration platform within integration environment 140. It should be understood that multiple users, on multiple user systems 130, may manage the same integration process(es) 160 and/or different integration processes 160 in this manner, according to the permissions or roles of their associated user accounts.

Although only a single integration process 160 is illustrated, it should be understood that, in reality, integration environment 140 may comprise any number of integration processes 160. In an embodiment, integration environment 140 supports integration platform as a service (iPaaS). In this case, integration environment 140 may comprise one or a plurality of integration platforms that each comprises one or a plurality of integration processes 160. Each integration platform may be associated with an organization, which may be associated with one or more user accounts by which respective user(s) manage the organization's integration platform, including the various integration process(es) 160.

An integration process 160 may represent any transaction involving the integration of data between two or more systems, and may comprise a series of elements that specify logic and transformation requirements for the data to be integrated. Each element, which may also be referred to herein as a “step” and have a visual representation referred to herein as a “shape,” may transform, route, and/or otherwise manipulate data to attain an end result from input data. For example, a basic integration process 160 may receive data from one or more data sources (e.g., via an application programming interface 162 of the integration process 160), manipulate the received data in a specified manner (e.g., including mapping, analyzing, normalizing, altering, updating, enhancing, and/or augmenting the received data), and send the manipulated data to one or more specified destinations (e.g., via an application programming interface of each destination). An integration process 160 may represent a business workflow or a portion of a business workflow or a transaction-level interface between two systems, and comprise, as one or more elements, software modules that process data to implement the business workflow or interface. A business workflow may comprise any myriad of workflows of which an organization may repetitively have need. For example, a business workflow may comprise, without limitation, procurement of parts or materials, manufacturing a product, selling a product, shipping a product, ordering a product, billing, managing inventory or assets, providing customer service, ensuring information security, marketing, onboarding or offboarding an employee, assessing risk, obtaining regulatory approval, reconciling data, auditing data, providing information technology services, and/or any other workflow that an organization may implement in software.

The functionality of server application 112 may include a process for constructing an integration process 160 within one or more screens of a graphical user interface of user interface 150. Embodiments of such functionality are disclosed, for example, in U.S. Pat. No. 8,533,661, issued on Sep. 10, 2013, and U.S. Pat. No. 11,886,965, issued on Jan. 30, 2024, which are both hereby incorporated herein by reference as if set forth in full, and referred to hereafter as “the GUI applications.” In particular, the GUI applications describe functionality that enable the construction of integration processes 160 on a virtual canvas.

Each integration process 160, when deployed, may be communicatively coupled to network(s) 120. For example, each integration process 160 may comprise an application programming interface (API) 162 that enables clients to access integration process 160 via network(s) 120. A client may push data to integration process 160 through application programming interface 162, and/or pull data from integration process 160 through application programming interface 162.

One or more third-party systems 170 may be communicatively connected to network(s) 120, such that each third-party system 170 may communicate with an integration process 160 in integration environment 140 via application programming interface 162. Third-party system 170 may host and/or execute a software application that pushes data to integration process 160 and/or pulls data from integration process 160, via application programming interface 162. Additionally or alternatively, an integration process 160 may push data to a software application on third-party system 170 and/or pull data from a software application on third-party system 170, via an application programming interface of the third-party system 170. Thus, third-party system 170 may be a client or consumer of one or more integration processes 160, a data source for one or more integration processes 160, and/or the like. As examples, the software application on third-party system 170 may comprise, without limitation, enterprise resource planning (ERP) software, customer relationship management (CRM) software, accounting software, and/or the like.

### 2. Example Processing System

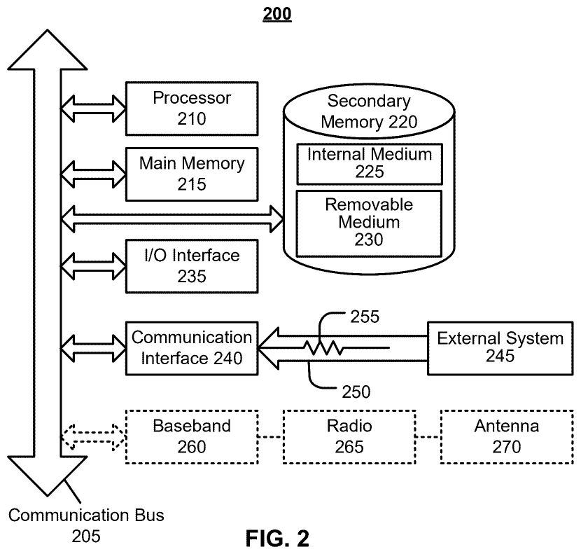

FIG. 2 illustrates an example processing system, by which one or more of the processes described herein may be executed, according to an embodiment. For example, system 200 may be used to store and/or execute server application 112, and/or may represent components of platform 110, user system(s) 130, third-party system 170, and/or other processing devices described herein. System 200 can be any processor-enabled device (e.g., server, personal computer, etc.) that is capable of wired or wireless data communication. Other processing systems and/or architectures may also be used, as will be clear to those skilled in the art.

System 200 may comprise one or more processors 210. Processor(s) 210 may comprise a central processing unit (CPU). Additional processors may be provided, such as a graphics processing unit (GPU), an auxiliary processor to manage input/output, an auxiliary processor to perform floating-point mathematical operations, a special-purpose microprocessor having an architecture suitable for fast execution of signal-processing algorithms (e.g., digital-signal processor), a subordinate processor (e.g., back-end processor), an additional microprocessor or controller for dual or multiple processor systems, and/or a coprocessor. Such auxiliary processors may be discrete processors or may be integrated with a main processor 210. Examples of processors which may be used with system 200 include, without limitation, any of the processors (e.g., Pentium™, Core i7™, Core i9™, Xeon™, etc.) available from Intel Corporation of Santa Clara, California, any of the processors available from Advanced Micro Devices, Incorporated (AMD) of Santa Clara, California, any of the processors (e.g., A series, M series, etc.) available from Apple Inc. of Cupertino, any of the processors (e.g., Exynos™) available from Samsung Electronics Co., Ltd., of Seoul, South Korea, any of the processors available from NXP Semiconductors N.V. of Eindhoven, Netherlands, any of the processors available from Nvidia Corporation of Santa Clara, California, and/or the like.

Processor(s) 210 may be connected to a communication bus 205. Communication bus 205 may include a data channel for facilitating information transfer between storage and other peripheral components of system 200. Furthermore, communication bus 205 may provide a set of signals used for communication with processor 210, including a data bus, address bus, and/or control bus (not shown). Communication bus 205 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 488 general-purpose interface bus (GPIB), IEEE 696/S-100, and/or the like.

System 200 may comprise main memory 215. Main memory 215 provides storage of instructions and data for programs executing on processor 210, such as any of the software discussed herein. It should be understood that programs stored in the memory and executed by processor 210 may be written and/or compiled according to any suitable language, including without limitation C/C++, Java, JavaScript, Perl, Python, Visual Basic, .NET, and the like. Main memory 215 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

System 200 may comprise secondary memory 220. Secondary memory 220 is a non-transitory computer-readable medium having computer-executable code and/or other data (e.g., any of the software disclosed herein) stored thereon. In this description, the term “computer-readable medium” is used to refer to any non-transitory computer-readable storage media used to provide computer-executable code and/or other data to or within system 200. The computer software stored on secondary memory 220 is read into main memory 215 for execution by processor 210. Secondary memory 220 may include, for example, semiconductor-based memory, such as programmable read-only memory (PROM), erasable programmable read-only memory (EPROM), electrically erasable read-only memory (EEPROM), and flash memory (block-oriented memory similar to EEPROM).

Secondary memory 220 may include an internal medium 225 and/or a removable medium 230. Internal medium 225 and removable medium 230 are read from and/or written to in any well-known manner. Internal medium 225 may comprise one or more hard disk drives, solid state drives, and/or the like. Removable storage medium 230 may be, for example, a magnetic tape drive, a compact disc (CD) drive, a digital versatile disc (DVD) drive, other optical drive, a flash memory card or drive, and/or the like.

System 200 may comprise an input/output (I/O) interface 235. I/O interface 235 provides an interface between one or more components of system 200 and one or more input and/or output devices. Examples of input devices include, without limitation, sensors, keyboards, touch screens or other touch-sensitive devices, cameras, biometric sensing devices, computer mice, trackballs, pen-based pointing devices, and/or the like. Examples of output devices include, without limitation, other processing systems, cathode ray tubes (CRTs), plasma displays, light-emitting diode (LED) displays, liquid crystal displays (LCDs), printers, vacuum fluorescent displays (VFDs), surface-conduction electron-emitter displays (SEDs), field emission displays (FEDs), and/or the like. In some cases, an input and output device may be combined, such as in the case of a touch-panel display (e.g., in a smartphone, tablet computer, or other mobile device).

System 200 may comprise a communication interface 240. Communication interface 240 allows software to be transferred between system 200 and external devices, networks, or other information sources. For example, computer-executable code and/or data may be transferred to system 200 from a network server via communication interface 240. Examples of communication interface 240 include a built-in network adapter, network interface card (NIC), Personal Computer Memory Card International Association (PCMCIA) network card, card bus network adapter, wireless network adapter, Universal Serial Bus (USB) network adapter, modem, a wireless data card, a communications port, an infrared interface, an IEEE 1394 fire-wire, and any other device capable of interfacing system 200 with a network (e.g., network(s) 120) or another computing device. Communication interface 240 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software transferred via communication interface 240 is generally in the form of electrical communication signals 255. These signals 255 may be provided to communication interface 240 via a communication channel 250 between communication interface 240 and an external system 245. In an embodiment, communication channel 250 may be a wired or wireless network (e.g., network(s) 120), or any variety of other communication links. Communication channel 250 carries signals 255 and can be implemented using a variety of wired or wireless communication means including wire or cable, fiber optics, conventional phone line, cellular phone link, wireless data communication link, radio frequency (“RF”) link, or infrared link, just to name a few.

Computer-executable code is stored in main memory 215 and/or secondary memory 220. Computer-executable code can also be received from an external system 245 via communication interface 240 and stored in main memory 215 and/or secondary memory 220. Such computer-executable code, when executed, enables system 200 to perform one or more of the various processes disclosed herein.

In an embodiment that is implemented using software, the software may be stored on a computer-readable medium and initially loaded into system 200 by way of removable medium 230, I/O interface 235, or communication interface 240. In such an embodiment, the software is loaded into system 200 in the form of electrical communication signals 255. The software, when executed by processor 210, may cause processor 210 to perform one or more of the various processes disclosed herein.

System 200 may optionally comprise wireless communication components that facilitate wireless communication over a voice network and/or a data network (e.g., in the case of user system 130). The wireless communication components comprise an antenna system 270, a radio system 265, and a baseband system 260. In system 200, radio frequency (RF) signals are transmitted and received over the air by antenna system 270 under the management of radio system 265.

In an embodiment, antenna system 270 may comprise one or more antennae and one or more multiplexors (not shown) that perform a switching function to provide antenna system 270 with transmit and receive signal paths. In the receive path, received RF signals can be coupled from a multiplexor to a low noise amplifier (not shown) that amplifies the received RF signal and sends the amplified signal to radio system 265.

In an alternative embodiment, radio system 265 may comprise one or more radios that are configured to communicate over various frequencies. In an embodiment, radio system 265 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from radio system 265 to baseband system 260.

If the received signal contains audio information, baseband system 260 decodes the signal and converts it to an analog signal. Then, the signal is amplified and sent to a speaker. Baseband system 260 also receives analog audio signals from a microphone. These analog audio signals are converted to digital signals and encoded by baseband system 260. Baseband system 260 also encodes the digital signals for transmission and generates a baseband transmit audio signal that is routed to the modulator portion of radio system 265. The modulator mixes the baseband transmit audio signal with an RF carrier signal, generating an RF transmit signal that is routed to antenna system 270 and may pass through a power amplifier (not shown). The power amplifier amplifies the RF transmit signal and routes it to antenna system 270, where the signal is switched to the antenna port for transmission.

Baseband system 260 may be communicatively coupled with processor(s) 210, which have access to memory 215 and 220. Thus, software can be received from baseband processor 260 and stored in main memory 210 or in secondary memory 220, or executed upon receipt. Such software, when executed, can enable system 200 to perform one or more of the various processes disclosed herein.

### 3. Construction Process

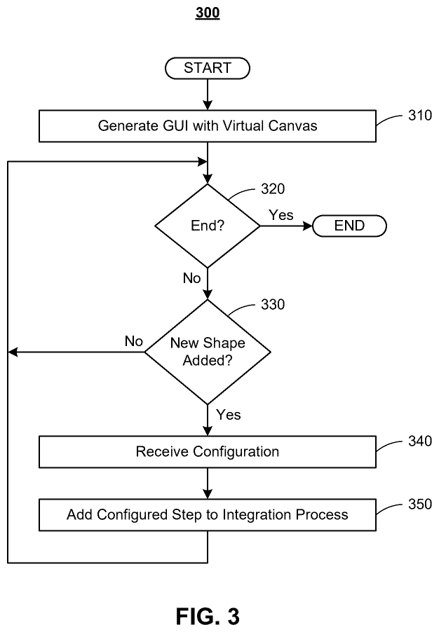

FIG. 3 illustrates an example process 300 for constructing an integration process 160, according to an embodiment. Process 300 may be implemented in server application 112. While process 300 is illustrated with a certain arrangement and ordering of subprocesses, process 300 may be implemented with fewer, more, or different subprocesses and a different arrangement and/or ordering of subprocesses. Furthermore, any subprocess, which does not depend on the completion of another subprocess, may be executed before, after, or in parallel with that other independent subprocess, even if the subprocesses are described or illustrated in a particular order.

Initially, subprocess 310 may generate a graphical user interface of user interface 150 for the construction of an integration process 160. The graphical user interface may comprise a virtual palette that comprises one or more shapes, representing potential steps in an integration process 160. In addition, the graphical user interface may comprise a virtual canvas that comprises a region onto which each shape, on the virtual palette, can be dragged and dropped to construct the integration process 160. In particular, the user may drag shapes, representing steps, onto the virtual canvas, and then connect those shapes. It should be understood that each shape represents a specific function, performed by a step within integration process 160, and the connections between shapes represent the data flow between the respective steps. Thus, the user may intuitively construct an integration process 160 by simply placing shapes on the virtual canvas and connecting those shapes together, to define data flows between the steps represented by those shapes. Embodiments of the graphical user interface are disclosed in the GUI applications.

Subprocess 320 may determine whether or not to end process 300. Subprocess 320 may determine to end process 300 when the user saves and/or deploys a final version of the integration process 160 under construction, navigates away from the current screen (i.e., comprising the virtual canvas) of the graphical user interface, discards integration process 160 or otherwise cancels construction of integration process 160, and/or the like. When determining to end (i.e., “Yes” in subprocess 320), process 300 may end. Otherwise, when not determining to end (i.e., “No” in subprocess 320), process 300 may proceed to subprocess 330.

Subprocess 330 may determine whether or not a new shape has been added to the visual representation of integration process 160 under construction. For example, the user may drag and drop a new shape onto the virtual canvas, at a position that is representative of the position of the step, represented by the new shape, within the data flow of integration process 160. Thus, process 300 may receive a user operation that comprises dragging and dropping the shape onto the virtual canvas. When a new shape has been added (i.e., “Yes” in subprocess 330), process 300 may proceed to subprocess 340. Otherwise, until a new shape is added (i.e., “No” in subprocess 330), process 300 may return to subprocess 320 to await the end of process 300 or the addition of a new shape.

Subprocess 340 may receive a configuration for the step, represented by the new shape that was added in subprocess 330. For example, when the new shape is dropped onto the virtual canvas and/or in response to a separate user operation or other trigger, the graphical user interface may provide a pop-up dialog box or other set of inputs that prompt the user to provide values for one or more configurable parameters of the step. It should be understood that the configurable parameters may depend on the type of step that has been added. For example, the configurable parameters will differ for a connector step representing a connection to a data source or destination, which may identify a uniform resource locator (URL), port number, application programming interface to be used, other connection details, and/or the like, than for a mapping step representing a data mapping between two data schemas, which may define a mapping between fields of the two data schemas, functions that convert field(s) in one data schema to field(s) in the other data schema, and/or the like. The user may input values for each configurable parameter and submit those input values via a user operation (e.g., selection of a submission input).

Subprocess 350 may add the configured step to the integration process 160 under construction. In particular, the step, represented by the shape added in subprocess 330, in association with the configuration, received in subprocess 340, may be added to an internal data representation of integration process 160. For example, software code, representing the added step, configured according to the received configuration, may be incorporated into integration code representing integration process 160. Connections between the step and one or more other steps in integration process 160 may also be added to the internal data representation of integration process 160. Process 300 may then return to subprocess 320 to await the end of process 300 or the addition of a new shape.

Of particular relevance to disclosed embodiments, the step that is added to integration process 160 may be an AI step that includes the application of an AI model to data flowing through integration process 160. In other words, the shape that is added in subprocess 330 may represent an AI model, the configuration received in subprocess 340 may comprise a configuration of the AI step, including values of the configurable parameters of the AI model, and the configured AI step that is added to integration process 160 in subprocess 350 may incorporate the application of the AI model into integration process 160.

Notably, the AI step may be added to integration process 160 in the same manner as any other step (e.g., connector steps, mapping steps, transformation steps, decision steps, etc.). The graphical user interface may comprise a virtual palette that includes one or more shapes which can be dragged and dropped anywhere on the virtual canvas. At least one of these shapes may represent an AI model, which can be dragged and dropped on the virtual canvas in the same manner as any other shape. From the user's perspective, there is no difference between adding an AI step, representing the application of the AI model, and any other step, except that the set of configurable parameters may differ in subprocess 340. Thus, users, already familiar with how to use the virtual canvas, can easily integrate their imported AI models into their integration processes 160 with little-to-no learning curve.

The configurable parameters for the AI model may differ for different AI models and/or for different types of AI models. Examples of configurable parameters of an AI model include, without limitation, an input schema (e.g., representing the data needed to derive the input to the AI model), an output schema (e.g., representing the data to be output from the AI step), output data handling, the URL of the AI model, port number, the application programming interface of the AI model, other connection details, the version information for the AI model, one or more execution parameters of the AI model, source(s) of the contextual metadata to be incorporated into the AI model input, field(s) from the contextual metadata to be incorporated into the AI model input, and/or the like.

The AI model may comprise any type of artificial intelligence, including any type of machine-learning model. Examples of machine-learning models include, without limitation, an artificial neural network (e.g., a deep-learning neural network (DNN), recurrent neural network (RNN), graph neural network (GNN), or the like), a random forest algorithm, a linear regression algorithm, a logistic regression algorithm, a decision tree, a support vector machine (SVM), a naïve Bayes algorithm, a k-Nearest Neighbors (kNN) algorithm, a K-means algorithm, a dimensionality reduction algorithm, a gradient-boosting algorithm, a Markov chain, a compact prediction tree (CPT), and/or the like.

The machine-learning model may be trained using historical integration data, which may comprise representations of previously constructed and executed integration processes, execution results, and/or the like. The historical integration data may be collected from a plurality of integration platforms managed through and executed by an iPaaS platform, such as the Boomi® iPaaS platform. The iPaaS platform may support a plurality of integration platforms, each managed by a different organizational account that is associated with one or more user accounts. In this case, the historical integration data may represent a massive repository of previously executed integration processes 160 that is very diverse in terms of structures, configurations, applications, inputs and outputs, and the like, and potentially crowd-sourced from a diverse group of organizations. Alternatively, the machine-learning model may be trained using other types of data. It should be understood that the training data that are used will depend on the type of machine-learning model and the specific task performed by the machine-learning model.

As a specific example, the AI model may comprise a generative model, such as a generative language model. In this case, the AI step that is added to integration process 160 may generate a prompt from the AI model input, input the generated prompt to the generative language model, and send the resulting output of the generative language model to the next step in integration process 160. The generated prompt and/or the resulting output may comprise a natural-language expression. As used herein, the term “natural language” or “natural-language” refers to language, including grammar, that would be expected in a normal conversation between two humans. Alternatively or additionally, the generated prompt and/or the resulting output may comprise data structures, other machine-readable data or non-natural-language expressions, and/or the like. For example, in the case of a generative image model, the generated prompt may comprise or consist of a natural-language expression, whereas the resulting output may comprise image data representing an image.

A generative language model may comprise or consist of a large language model. One well-known example of a large language model is the Generative Pre-trained Transformer (GPT). GPT-4 is the fourth-generation language prediction model in the GPT-n series, created by OpenAI™ of San Francisco, California. GPT-4 is an autoregressive language model that uses deep learning to produce human-like text. GPT-4 has been pre-trained on a vast amount of text from the open Internet. While GPT-4 is provided as an example, it should be understood that the generative language model may be any generative language model, including past and future generations of GPT, as well as other large language models, such as any of the Claude family of large language models (e.g., Claude 3 Opus) developed by Anthropic PBC of San Francisco, California, the Falcon large language model (e.g., Falcon 180B) released by the United Arab Emirates' Technology Innovation Institute (TII), the Large Language Model Meta AI (LLaMA) model (e.g., LLaMA 2) released by Meta AI of New York, New York, the Gemini model, the Mistral family of models released by Mistral AI of Paris, France, and the like. Alternatively or additionally, the generative language model may comprise or consist of a code-completion model that is trained to produce source code, data structures represented in a markup language (e.g., XML, HTML, etc.) or other format, and/or the like. A pre-trained generative language model may used as a base model that is fine tuned for an intended task, to produce the generative language model used in the AI step of integration process 160.

The AI step may generate the prompt for the generative language model by inserting input data, provided by at least one preceding step, into a predefined template. The predefined template may comprise a pre-conversation and/or post-conversation, which provide context and/or instructions for the generative language model, and a placeholder into which the input data are inserted. The pre-conversation and/or post-conversation may define the role of the generative language model, which may include summarizing the input data, classifying the input data into one of a plurality of classifications (e.g., fraudulent vs. non-fraudulent, sentiment, etc.), generate a communication, such as an email message, text message, advertisement, and/or the like, from the input data, generate a data structure from the input data, and/or the like. The pre-conversation and/or post-conversation may also define an output format for the generative language model (e.g., a list structure, a hierarchical structure, a markup-language structure, etc.), and/or perform other functions.

Advantageously, process 300 introduces the ability to define and integrate any open-source, fine-tuned, custom, and/or cutting-edge AI model (e.g., large language model) into one or more integration processes 160 of an integration platform. The user no longer has to rely on the platform provider's curation of AI models or wait for the platform provider to make new AI models or new versions of existing AI models available. For example, a user may import any desired AI model into the integration platform and utilize process 300 to seamlessly integrate that AI model into any integration process 160 on the user's integration platform. The ability to bring your own model (BYOM) in this manner, ensures that users can receive the benefit of AI models that are finely tuned to their specific data, needs, and user cases, resulting in significantly improved performance and accuracy of their integration processes 160. In addition to this enhanced customization, process 300 provides increased flexibility. In particular, by supporting various formats of AI models and state-of-the-art AI models (e.g., large language models) with easy configuration (e.g., in subprocess 340), users are able to design highly customized integration processes 160 (e.g., workflows) that can address a wide range of applications, from customer support to fraud detection and everywhere in between and beyond. In summary, disclosed embodiments enable users to easily integrate any open-source, pre-trained, and/or custom AI model (e.g., large language model) into the data flow of any integration process 160, in the same manner as any other step, to obtain the desired ownership and customization for their integration needs.

### 4. Execution Process

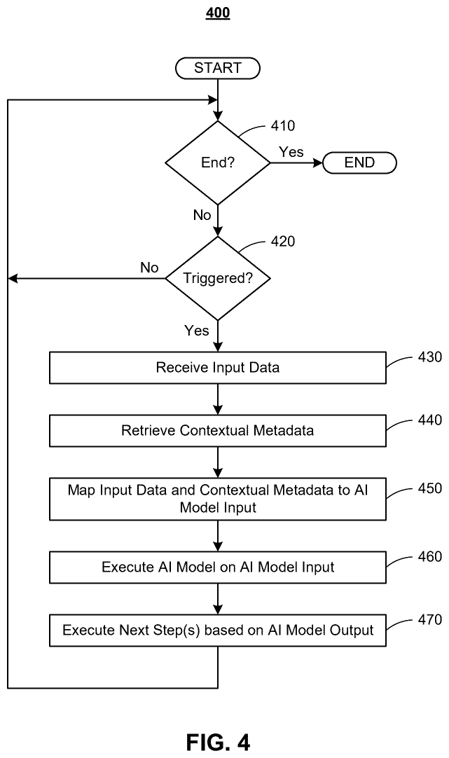

FIG. 4 illustrates an example process 400 for executing an integration process 160, according to an embodiment. Process 400 may be implemented in server application 112. While process 400 is illustrated with a certain arrangement and ordering of subprocesses, process 400 may be implemented with fewer, more, or different subprocesses and a different arrangement and/or ordering of subprocesses. Furthermore, any subprocess, which does not depend on the completion of another subprocess, may be executed before, after, or in parallel with that other independent subprocess, even if the subprocesses are described or illustrated in a particular order.

Once integration process 160 has been deployed, integration process 160 may execute in a runtime container within integration environment 140. In particular, deploying integration process 160 may comprise generating a runtime container that comprises the integration code representing integration process 160, including the software code for each step in the integration process 160. Deploying integration process 160 may also comprise running at least one instance of the runtime container in a computing cloud. Thus, integration process 160 can be executed as a stand-alone runtime container, which can be run independently of and in parallel with other runtime containers, for example, in a cloud environment. This enables instances of the integration process 160 to be dynamically and elastically scaled up or down, depending on demand, by simply instantiating (i.e., “spinning up”) or terminating (i.e., “spinning down”) their respective runtime containers. Process 400 may be performed independently for each runtime container.

Of particular relevance to disclosed embodiments, the integration code in the runtime container may comprise the software code for each AI step, representing execution of an AI model (e.g., a generative model, such as a generative language model, such as a large language model). The software code for an AI step may call an external AI model, for example, at a URL specified for the AI model, using an application programming interface for the AI model, with parameters representing the AI model input and potentially execution settings for the AI model.

In an embodiment, the AI model may itself be dockerized into a model container. The model container may comprise the AI model and all dependencies of the AI model. This enables the AI model to be run without any reliance on external services, which ensures low latency and local (e.g., secure) processing. Thus, the AI model can be executed as a stand-alone model container, which can be run independently of and in parallel with other model containers, for example, in a cloud environment. This enables instances of the AI model to be dynamically and elastically scaled up or down, depending on demand, by simply instantiating (i.e., “spinning up”) or terminating (i.e., “spinning down”) their respective model containers. In addition, a single model container may service AI steps in a plurality of integration processes 160 (e.g., in a plurality of respective runtime containers). Alternatively, the model container may be packaged into a runtime container for an integration process 160, such that the integration process 160 has a local copy of the AI model within its runtime container.

The dockerization of the AI model into a model container also enables the AI model to be updated (e.g., retrained) without any downtime, which is vital for industries that require rapid AI models. In particular, the old version of the AI model may, within its model container, continue to service requests from one or more runtime containers, while a new version of the AI model is updated. Once the update is complete, a model container with the new version of the AI model may be instantiated, while the model container with the old version of the AI model may be terminated. The model container with the new version of the AI model may be provided at the same address as the model container with the old version of the AI model, so that the switch is seamless from the perspective of the runtime containers.

Subprocess 410 may determine whether or not to end process 400. Subprocess 410 may determine to end process 400 when integration process 160 or the runtime container of integration process 160 is terminated (e.g., automatically in response to a decrease in demand, in response to a user or automated operation that un-deploys integration process 160 or the integration platform that contains integration process 160, etc.). When determining to end (i.e., “Yes” in subprocess 410), process 400 may end. Otherwise, when not determining to end (i.e., “No” in subprocess 410), process 400 may proceed to subprocess 420.

Subprocess 420 may determine whether or not integration process 160 has been triggered. Subprocess 420 may determine that integration process 160 has been triggered when input data to be integrated are pushed to integration process 160, a user operation is received, one or more automated criteria for pulling input data to be integrated are satisfied (e.g., expiration of a time interval), a triggering event is produced by another integration process 160 or third-party application, and/or the like. When determining that integration process 160 has been triggered (i.e., “Yes” in subprocess 420), process 400 may proceed to subprocess 430. Otherwise, when not determining that integration process 160 has been triggered (i.e., “No” in subprocess 420), process 400 may return to subprocess 410 to await the end of process 400 or for integration process 160 to be triggered.

Subprocess 430 may receive the input data for integration process 160. The input data may be either pushed by a data source to integration process 160 or pulled by integration process 160 from a data source. The data source may comprise another integration process 160, a third-party application, database 114, and/or the like. The input data may comprise any type of data to be integrated. Subprocess 430 may be implemented by a connector step in integration process 160.

Subprocess 440 may retrieve contextual metadata. The contextual metadata comprise data about the input data that provides context for, or additional context to, the input data. For example, if the input data represent a commercial transaction or metadata for the commercial transaction, the contextual metadata may comprise customer information about the customer or business involved in the transaction, such as a customer history (e.g., transaction history comprising records of any past transactions, past interactions with customer support provided by the business, etc.), the customer's past support interactions, product data (e.g., viewed items, cart history, etc.), user behavior (e.g., time spent on a webpage, geolocation of the customer, etc.), timestamp for the transaction (e.g., when integration process 160 was triggered), and/or the like. As another example, if the input data represent a website visit, the contextual metadata may comprise an identifier of the visitor, identifier of each viewed webpage, cart activity, session duration, and/or the like. It should be understood that these are non-limiting examples, and that the contextual metadata may comprise any data about the input data that is capable of providing context to the input data. The contextual metadata may include structured and/or unstructured data. Essentially, subprocess 440 enhances the input data with context that can be used by the AI model to produce a more accurate AI model output. Subprocess 440 may be implemented by a connector step in integration process 160.

Subprocess 450 may map the input data, received in subprocess 430, and/or the contextual metadata, retrieved in subprocess 440, to an AI model input. In particular, subprocess 450 may map an input schema, representing a structure of the input data and/or the contextual metadata, to an output schema. The input schema may comprise or consist of a hierarchical structure that defines each field in the input data and/or contextual metadata, and the output schema may comprise or consist of a hierarchical structure that defines each field in the AI model input. A single field in the input schema may be mapped to a single field in the output schema, two or more fields in the input schema may be mapped to a single field in the output schema, a single field in the input schema may be mapped to a plurality of fields in the output schema, a plurality of fields in the input schema may be mapped to a plurality of fields in the output schema, and/or the like. There may also be instances in which a field in the input schema does not map to any field in the output schema, or a field in the output schema does not map to any field in the input schema. In this latter case, the output schema may comprise a default value for any missing fields. The mapping of one or more fields in the input schema to one or more fields in the output schema may, in some instance, comprise executing a function that converts (e.g., via string concatenation, string splitting, mathematical calculation, etc.) the field(s) in the input schema to the field(s) in the output schema. Subprocess 450 may be implemented by a mapping step in integration process 160.

Subprocess 460 may execute the AI model on the AI model input, produced by subprocess 450. Subprocess 460 may be implemented by the AI step discussed elsewhere herein. In particular, subprocess 460 may execute the AI step to apply the AI model, configured according to a received configuration (e.g., received in subprocess 340), to the AI model input to produce an AI model output. In the event that the AI model is a generative language model, such as a large language model, the execution of the AI step may comprise generating a prompt from the AI model input, and inputting the prompt to the large language model or other generative language model. The prompt may be generated using a template that defines a pre-conversation and/or post-conversation, as discussed elsewhere herein. For example, the generation of the prompt may comprise inserting one or more fields from the AI model input (e.g., represented in a hierarchical structure of the output schema from subprocess 450) into the template to produce the prompt.

Subprocess 470 may comprise executing at least one subsequent step, in integration process 160, on the AI model output, resulting from the execution of the AI model in subprocess 460 (e.g., the AI step). The subsequent step(s) may comprise any type of step that may be found in an integration process 160. For example, the subsequent step(s) may comprise a mapping step that maps the AI model output into a different data schema, a connector step that sends the AI model output to at least one data destination (e.g., another integration process 160, a third-party application, a user dashboard, etc.), a transformation step that transforms the AI model output into new data, a decision step that selects a next step based on the AI model output, an analysis step that analyzes the AI model output to produce analytic data, a setting step that sets one or more properties of integration process 160 based on the AI model output, and/or the like. After subprocess 470, process 400 may return to subprocess 410 to await the end of process 400 or for integration process 160 to be triggered again.

In an embodiment, platform 110 monitors performance metrics of integration processes 160, within integration environment 140, in real time. Of particular relevance to disclosed embodiments, these real-time performance metrics may comprise one or more performance metrics of each AI model. For example, the performance metrics of an AI model may include the accuracy and/or latency of the AI model. Platform 110 may provide automated alerts (e.g., configurable by users) that trigger a notification to a user or other system when the performance metric(s) of an AI model satisfy one or more criteria (e.g., fall below a predefined threshold). This enables a user to dynamically modify the configuration of an AI model, or integration process 160 that utilizes an AI model, for example, when the real-time performance metric(s) indicate that the performance of the AI model is insufficient or could be improved.

### 5. Graphical User Interface

Boomi® provides an iPaaS platform that has revolutionized the integration/middleware space with a drag-and-drop graphical user interface that eliminates the need for custom code in the construction of integration processes 160. In particular, the graphical user interface comprises a virtual canvas over which a user may drag and drop shapes, representing steps that perform specific functions, and connect the shapes to define data flows between their respective functions. Of particular relevance to disclosed embodiments, at least one shape may represent an AI step. Thus, the user may intuitively construct an integration process 160, including integrating an AI model into the integration process 160, by simply adding, configuring, and connecting shapes in an intuitive manner, within a low-code or no-code integration development environment.

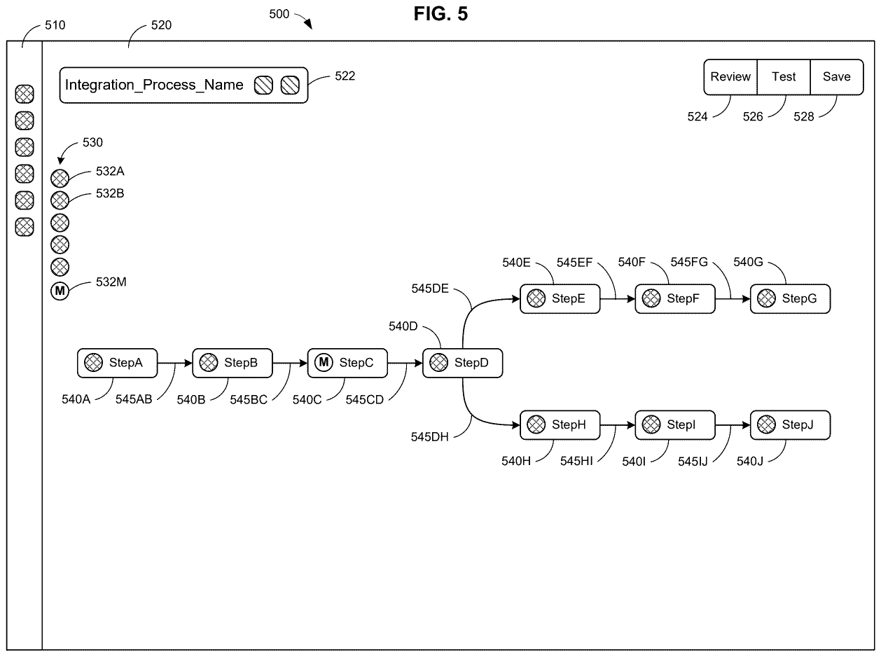

FIG. 5 illustrates an example graphical user interface 500 that may be used to construct an integration process 160, according to an embodiment. Graphical user interface 500 may be provided by user interface 150 of server application 112. In the illustrated example, graphical user interface 500 comprises a navigation bar 510, a virtual canvas 520, and a virtual palette 530. Virtual canvas 520 enables a user to drag representations (i.e., “shapes”) of steps, from virtual palette 530, drop those representations on a region of virtual canvas 520 at respective positions within an integration process 160 being constructed, and connect those representations to form one or more paths for data to flow through the integration process 160.

Virtual canvas 520 may comprise a header 522 which may include information (e.g., name) for the integration process 160 as a whole. In addition, virtual canvas 520 may comprise a review input 524 for triggering an analysis (e.g., error prediction) of integration process 160, a test input 526 for testing integration process 160 (e.g., executing integration process 160 in a test environment), and a save input 528 for saving integration process 160 in the current configuration.

Virtual palette 530 may comprise a plurality of shapes 532, illustrated as shapes 532A, 532B, . . . , and 532M. Each shape 532 represents a template for a type of step that can be added to integration process 160. A user may drag any shape 532 from virtual palette 530 onto virtual canvas 520, to incorporate an instance of the corresponding step into integration process 160. The user may then specify the value(s) of one or more configurable parameters (e.g., via a dialog box that is displayed automatically after dropping the shape onto virtual canvas 520 and/or in response to a user selection of the shape on virtual canvas 520), to configure the corresponding step within integration process 160.

In an embodiment, virtual palette 530 comprises at least one shape 532M that represents an AI model (e.g., large language model). While only one shape 532M is illustrated, it should be understood that virtual palette 530 may comprise any number of shapes 532M. In this case, each shape 532M may represent a different AI model. Each AI model may be provided by the operator of platform 110 and/or imported by the user into the user's integration platform. In the latter case, the AI model may represent a custom AI model that has been built and/or trained or otherwise acquired by the user, outside the confines of platform 110.

In the illustrated example, a user has constructed an integration process 160 with shapes 540A, 540B, 540C, 540D, 540E, 540F, 540G, 540H, 540I, and 540J, which each represents a step in integration process 160. Each of shapes 540 is connected to at least one adjacent shape 540 by a connection 545. In the illustrated example, shape 540A is connected to shape 540B by connection 545AB, shape 540B is connected to shape 540C by connection 545BC, shape 540C is connected to shape 540D by connection 545CD, shape 540D represents a branch that is connected to shape 540E by connection 545DE and is connected to shape 540H by connection 545DH, shape 540E is connected to shape 540F by connection 545EF, shape 540F is connected to shape 540G by connection 545FG, shape 540H is connected to shape 540I by connection 545HI, and shape 540I is connected to shape 540J by connection 545IJ. Because shape 540D represents a branch, there are two possible paths through integration process 160:540A-540B-540C-540D-540E-540F-540G; and 540A-540B-540C-540D-540H-540I-540J.

Notably, shape 540C represents an AI step (i.e., StepC) that has been created using shape 532M. Data flowing from StepA, represented by shape 540A, and/or StepB, represented by shape 540B, which may represent the input data and/or contextual metadata, may be incorporated into an AI model input that is provided to the AI step. The AI model output, from the AI model in the AI step, may then be provided to StepD, represented by shape 540D, which may be a decision step that makes a branching decision to either StepE, represented by shape 540E, or StepH, represented by shape 540H, based on the AI model output.

### 6. Example Use Cases

Using disclosed embodiments, a user may construct an integration process 160 that integrates a custom or any other user-desired AI model into the integration process 160. The user may integrate a specific AI model designed to perform a specific task on the data flowing through the integration process 160. Examples of such tasks include, without limitation, transforming data, performing sentiment analysis (e.g., classifying textual data into one of a plurality of classes representing different sentiments), detecting fraud (e.g., classifying transaction data into either a fraud class, representing a likely fraudulent transaction, or a non-fraud class, representing a likely legitimate transaction), and/or the like. The integrated AI model may operate in real-time, as integration process 160 executes, automatically processing data and generating outputs as part of an automated workflow. Disclosed embodiments support both simple integration processes 160, as well as complex integration processes 160, enabling any integration process 160 to leverage the full capabilities of any user-desired AI model.

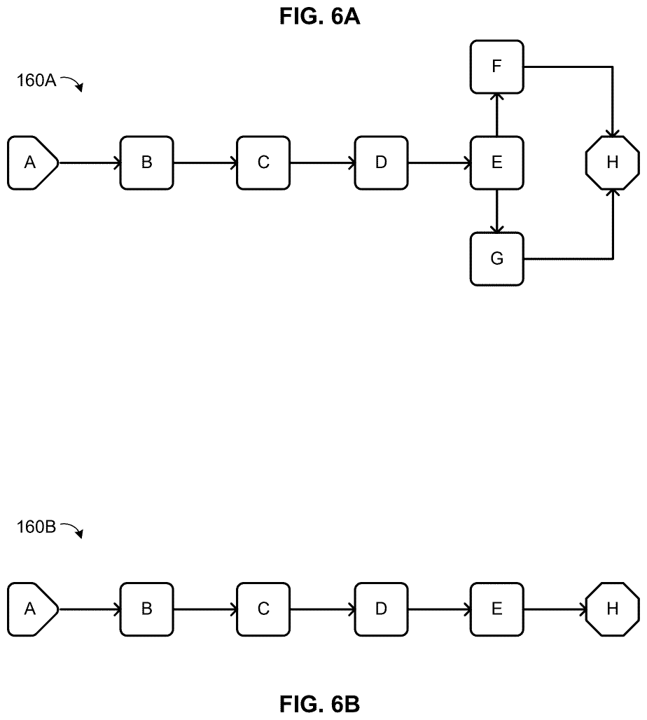

FIG. 6A illustrates an example integration process 160A, according to an embodiment that implements a first use case. In this first use case, an AI model is utilized to detect fraud in a transaction. Thus, the input data may represent a transaction involving a customer, the contextual metadata may comprise customer information, including a transaction history, and the AI model output may indicate whether or not the transaction is fraudulent. Whenever a transaction occurs, integration process 160A may be automatically triggered to evaluate the likelihood that the transaction is fraudulent.

Step A may represent a connector step that dynamically and automatically receives the input data (e.g., implementing subprocess 430), representing a transaction. The input data may comprise information about the transaction, such as an identifier of the customer involved in the transaction, an identification of the merchant involved in the transaction, a product (e.g., good or service) that is a subject of the transaction, an amount of the transaction, a timestamp representing the time of the transaction, and/or the like. The configurable parameters of Step A may comprise connection information (e.g., access information) for a database or application programming interface from which the input data are retrieved.

Step B may represent a connector step (e.g., database connector) that dynamically and automatically retrieves the contextual metadata (e.g., implementing subprocess 440) for the transaction. In particular, one or more fields from the input data (e.g., customer identifier, session identifier, transaction details, etc.) may be used by Step B to retrieve (e.g., query) the contextual metadata. The contextual metadata may comprise customer history (e.g., past transactions, past interactions with the merchant's customer support, etc.), product data (e.g., viewed items, virtual cart history, etc.), user behavior (e.g., time spent on one or more webpages, geolocation of the customer, etc.), a timestamp (e.g., representing the time at which integration process 160A was triggered or the input data were processed), and/or the like. The configurable parameters of Step B may comprise connection information for a database or application programming interface from which the contextual metadata are retrieved, the contextual metadata fields to be retrieved, and/or the like.

Essentially, Step B uses the contextual metadata to enhance the input data with context. In an embodiment the user may define the enrichment rules, representing how the metadata are gathered, merged, and formatted. For example, a user may set a rule that always retrieves the customer's last five transactions for the contextual metadata, dynamically adds the customer's location data to the contextual metadata when a geolocation is detected, and/or the like. These rules may be defined as configurable parameters of Step B during construction of integration process 160A, and applied dynamically during execution of integration process 160A, such that every execution of Step B automatically captures, enriches, and injects contextual metadata into the data flow, without any manual input.

Step C may represent a mapping step that dynamically and automatically maps the input data and the contextual metadata to an AI model input (e.g., implementing subprocess 450). In particular, Step C may map the input data and the contextual metadata to a structured format, represented by a data schema, required by the AI step.

Step D may be the AI step (e.g., implementing subprocess 460), which applies the AI model to the AI model input that is produced by Step C. In the use case of fraud detection, the AI model may comprise a generative language model (e.g., large language model) that is asked to determine whether or not the transaction, represented by the input data, is fraudulent. In this case, the AI step may generate a prompt from the AI model input (e.g., by inserting fields from the AI model input into a template), and input the prompt to the generative model, to produce an AI model output. Alternatively, the AI model may comprise a classifier that classifies features, derived from the AI model input, into either a fraud class, representing a fraudulent transaction, or non-fraud class, representing a legitimate transaction. In this case, the AI model output may be the class with the highest probability, or an output vector that comprises a probability of each class and in which all of the probabilities sum to one. In either case, the AI step may apply the AI model by sending the input (e.g., prompt or feature vector), derived from the AI model input, to a model container that contains the AI model, optionally with configurable execution parameters of the AI model, to thereby invoke the AI model.

Steps E, F, and G represent subsequent steps in integration process 160A (e.g., implementing subprocess 470). Step E may be a decision step that branches to one of two or more action steps based on the AI model output. In the use case of fraud detection, Step E may branch to Step F when the transaction is classified into the fraud class, and branch to Step G when the transaction is classified into the non-fraud class. In this case, Step F may comprise taking a remedial action to flag the transaction as fraudulent, including, without limitation, notifying one or more recipients (e.g., another integration process 160, a third-party application, the customer, the merchant, the credit card company for the credit card that was used in the transaction, etc.) that the transaction is likely fraudulent, blocking or reversing the transaction, initiating a corrective action, notifying law enforcement, and/or the like. Conversely, Step G may confirm the transaction as legitimate (e.g., by approving the transaction, notifying another integration process 160, a third-party application, the merchant, the credit card company, etc. that the transaction is legitimate, etc.), thereby allowing the transaction to proceed without interruption.

FIG. 6B illustrates an example integration process 160B, according to an embodiment that implements a second use case. In this second use case, an AI model is used to produce a marketing campaign. The input data may represent a website visit, the contextual metadata may comprise a browsing history, and the AI model output may comprise personalized marketing content, from which a subsequent step can generate at least one personalized communication (e.g., in the context of a marketing campaign).

Step A may represent a connector step that dynamically and automatically receives the input data (e.g., implementing subprocess 430), representing a visitor's interaction with a website (e.g., viewing a product webpage). In this case, integration process 160B may be triggered by a webhook, which may comprise an HTTP request that sends input data from the website to integration process 160B. The input data may comprise information about the interaction, such as an identifier of the customer involved in the transaction, the URL of the viewed webpage(s), a product (e.g., good or service) that is a subject of the viewed webpage(s), a timestamp representing the time of the transaction, and/or the like.

Step B may represent a connector step (e.g., HTTP API connector) that dynamically and automatically retrieves the contextual metadata (e.g., implementing subprocess 440) for the website visit, for example, from an e-commerce platform (e.g., via an application programming interface of the e-commerce platform). In particular, one or more fields from the input data (e.g., customer identifier, session identifier, etc.) may be used by Step B to retrieve (e.g., query) the contextual metadata. The contextual metadata may comprise the browsing history of webpages viewed by the visitor during the session, cart activity (e.g., items left in the cart), session duration, webpage view duration, past purchases, interaction patterns, and/or the like. Again, the contextual metadata are used to enrich the input data.

Step C may represent a mapping step that dynamically and automatically maps the input data and the contextual metadata to an AI model input (e.g., implementing subprocess 450). In particular, Step C may map the input data and the contextual metadata to a structured format, represented by a data schema, required by the AI step.

Step D may be the AI step (e.g., implementing subprocess 460), which applies the AI model to the AI model input that is produced by Step C. In the use case of personalized marketing, the AI model may comprise a generative language model (e.g., large language model) that is asked to produce personalized marketing content from the AI model input. In this case, the AI step may generate a prompt from the AI model input (e.g., by inserting fields from the AI model input into a template), and input the prompt to the generative model, to produce an AI model output. The prompt may further include a marketing template for the personalized marketing content, such that the generative model fills in the marketing template with content that is generated based on the AI model input. The personalized marketing content may comprise personalized product recommendations, offers, and/or the like. The AI step may apply the AI model by sending the input (e.g., prompt), derived from the AI model input, to a model container that contains the AI model, optionally with configurable parameters of the AI model, to thereby invoke the AI model.

Step E may represent a subsequent step in integration process 160B. In the use case of personalized marketing, Step E may generate at least one personalized communication from the personalized marketing content. For example, Step E may generate a personalized email message (e.g., with product offers), dynamically update a recommendation section of the website that the website visitor is viewing (e.g., with product recommendations), dynamically add a banner advertisement to a webpage being viewed by the website visitor (e.g., with a targeted offer), and/or the like, based on (e.g., including) the personalized marketing content.

Notably, the visitors interactions with the personalized communication(s) may be tracked, for example, by another integration process 160, third-party application, and/or the like. In particular, when the visitor clicks on a hyperlink, representing a product recommendation or offer, in the personalized communication, this click interaction may be recorded. These recorded interactions or the lack thereof may be fed back into the system, for example, to train the AI model to provide improved personalized marketing content. For instance, instances of personalized marketing content that produced a significant number or percentage of interactions may be used to positively reinforce the AI model, whereas instances of personalized marketing that did not produce a significant number of percentage of interactions may be used to negatively reinforce the AI model. Improving the personalized marketing content may include providing more accurate recommendations or offers (i.e., more likely to elicit an engagement), or otherwise improving engagement by visitors using the personalized communications generated from the personalized marketing content.

The above description of the disclosed embodiments is provided to enable any person skilled in the art to make or use the invention. Various modifications to these embodiments will be readily apparent to those skilled in the art, and the general principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

As used herein, the terms “comprising,” “comprise,” and “comprises” are open-ended. For instance, “A comprises B” means that A may include either: (i) only B; or (ii) B in combination with one or a plurality, and potentially any number, of other components. In contrast, the terms “consisting of,” “consist of,” and “consists of” are closed-ended. For instance, “A consists of B” means that A only includes B with no other component in the same context.

Combinations, described herein, such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, and any such combination may contain one or more members of its constituents A, B, and/or C. For example, a combination of A and B may comprise one A and multiple B's, multiple A's and one B, or multiple A's and multiple B's.

What is claimed is:

1. A method comprising using at least one hardware processor to:
generate a graphical user interface comprising a virtual palette and a virtual canvas, wherein the virtual palette comprises one or more shapes, representing potential steps in an integration process, wherein the virtual canvas comprises a region onto which each shape, on the virtual palette, is draggable and droppable to construct the integration process, and wherein at least one of the one or more shapes represents an artificial intelligence (AI) step in which an AI model is executed;
receive a user operation that comprises dragging and dropping the at least one shape, representing the AI model, onto the virtual canvas;
receive a configuration of the AI step;
incorporate software code, representing the AI step, configured according to the received configuration, into integration code representing the integration process; and
deploy the integration process.

2. The method of claim 1, wherein the AI model comprises a generative model.

3. The method of claim 2, wherein the generative model is a generative language model.

4. The method of claim 3, wherein the generative language model is a large language model.

5. The method of claim 1, further comprising using the at least one hardware processor to, after deploying the integration process, execute the integration process, wherein executing the integration process comprises:
receiving input data;
retrieving contextual metadata;
mapping the input data and the contextual metadata to an AI model input;
executing the AI step to apply the AI model, configured according to the received configuration, to the AI model input to produce an AI model output; and
executing at least one subsequent step, in the integration process, on the AI model output.

6. The method of claim 5, wherein the AI model comprises a machine-learning model.

7. The method of claim 5, where the AI model is a large language model.

8. The method of claim 7, wherein mapping the input data and the contextual metadata to the AI model input comprises mapping an input schema, representing a structure of the input data and the contextual metadata, to an output schema.

9. The method of claim 8, wherein executing the AI step comprises:
generating a prompt from the AI model input; and
inputting the prompt to the large language model to produce the AI model output.

10. The method of claim 1, wherein deploying the integration process comprises generating a runtime container that comprises the integration code, and wherein the integration process is executed within the runtime container.

11. The method of claim 10, wherein deploying the integration process further comprises running at least one instance of the runtime container in a computing cloud.

12. The method of claim 10, further comprising using the at least one hardware processor to dockerize the AI model into a model container that comprises the AI model and all dependencies of the AI model.

13. The method of claim 12, wherein applying the AI model comprises sending an input, derived from the AI model input, to the model container.

14. The method of claim 13, wherein applying the AI model further comprises sending one or more execution parameters, with the input derived from the AI model input, to the model container.

15. The method of claim 5, wherein the input data represent a transaction involving a customer, wherein the contextual metadata comprise customer information, including a transaction history, and wherein the AI model output indicates whether or not the transaction is fraudulent.

16. The method of claim 15, wherein the at least one subsequent step comprises a decision step and two or more action steps, wherein the decision step branches to one of the two or more action steps based on the indication of whether or not the transaction is fraudulent, wherein a first one of the two or more action steps flags the transaction as fraudulent, and wherein a second one of the two or more action steps confirms the transaction as legitimate.

17. The method of claim 5, wherein the input data represent a website visit, wherein the contextual metadata comprise a browsing history, and wherein the AI model output comprises personalized marketing content.

18. The method of claim 17, wherein the at least one subsequent step comprises generating at least one personalized communication from the personalized marketing content.

19. A system comprising:
at least one hardware processor; and
software that is configured to, when executed by the at least one hardware processor,
generate a graphical user interface comprising a virtual palette and a virtual canvas, wherein the virtual palette comprises one or more shapes, representing potential steps in an integration process, wherein the virtual canvas comprises a region onto which each shape, on the virtual palette, is draggable and droppable to construct the integration process, and wherein at least one of the one or more shapes represents an artificial intelligence (AI) step in which an AI model is executed,
receive a user operation that comprises dragging and dropping the at least one shape, representing the AI model, onto the virtual canvas,
receive a configuration of the AI step,
incorporate software code, representing the AI step, configured according to the received configuration, into integration code representing the integration process, and
deploy the integration process.

20. A non-transitory computer-readable medium having instructions stored therein, wherein the instructions, when executed by a processor, cause the processor to:
generate a graphical user interface comprising a virtual palette and a virtual canvas, wherein the virtual palette comprises one or more shapes, representing potential steps in an integration process, wherein the virtual canvas comprises a region onto which each shape, on the virtual palette, is draggable and droppable to construct the integration process, and wherein at least one of the one or more shapes represents an artificial intelligence (AI) step in which an AI model is executed;
receive a user operation that comprises dragging and dropping the at least one shape, representing the AI model, onto the virtual canvas;
receive a configuration of the AI step;
incorporate software code, representing the AI step, configured according to the received configuration, into integration code representing the integration process; and
deploy the integration process.
